(19) United States
(12) Patent Application Publication
(10) Pub. No.: US 2019/0128556 A1
(43) Pub. Date: May 2, 2019

(54) DEFROST SYSTEM AND METHOD FOR HEAT OR ENERGY RECOVERY VENTILATOR

(71) Applicant: AIRIA DEVEL, INC., London (CA)

(72) Inventor: Peter Karl GRINBERGS, Dorchester (CA)

(21) Appl. No.: 16/173,776

(22) Filed: Oct. 29, 2018

(30) Foreign Application Priority Data
Oct. 30, 2017 (GB) 1717799.9

(51) Int. Cl. F24F 12/00; F24F 11/41; F24F 13/14

(52) U.S. Cl. CPC F24F 12/006; F24F 2013/1433; F24F 13/1426; F24F 11/41

(57) ABSTRACT

Disclosed herein is a heat or energy recovery ventilator unit comprising: a housing; a heat exchanger core; an outgoing airflow conduit and an inlet and outlet for passage of the outgoing airflow; an incoming airflow conduit and an inlet and outlet for passage of incoming airflow; a blower for moving the outgoing and incoming airflows through the respective conduits; a damper and a damper drive to move the damper between a ventilation position and a defrost position on the unit; and a damper control system comprising a processor that causes the damper to be released from a frozen state on the unit by effecting clockwise and counter-clockwise rotation of a drive that actuates the damper, thereby releasing the damper from said frozen state. Further provided is a damper control system for a heat or energy recovery ventilator unit and a computer program product to control operation of the damper.

### TECHNICAL FIELD

The present techniques relate to a heat or energy recovery ventilator which employs one or more dampers for defrosting.

### BACKGROUND

This section is intended to introduce various aspects of the art, which may be associated with exemplary embodiments of the present techniques. This discussion is believed to assist in providing a framework to facilitate better understanding of particular aspects of the present techniques. Accordingly, it should be understood that this section should be read in this light, and not necessarily as admissions of prior art.

Heat or energy recovery ventilators (H/ERV) exhaust stale air from a building and introduce fresh air. In order to ensure adequate removal of exhaust stale air from a building to provide satisfactory air quality, heat or energy recovery ventilators were developed to simultaneously draw exhaust stale air from building spaces and replace the exhaust stale air with fresh air at a controlled rate. This can typically be performed without a substantial loss of heat energy. For example, when the building is being heated to a temperature greater than an outside temperature, a heat exchanger core in the heat or energy recovery ventilator is used to transfer waste heat from warm exhaust stale air to incoming cooler fresh air. Such energy recovery may be performed without mixing fresh and exhaust airflows.

When an H/ERV is used during heating of a building in a cold climate, the exhaust air processed by the H/ERV usually contains a certain amount of moisture. In such conditions, the moist exhaust stale air can condense and/or freeze as heat is transferred within the H/ERV. This can reduce heat transfer efficiency of H/ERV. In extreme cases, this can result in blockage of an exhaust airflow path and/or damage to the H/ERV.

One known method of defrosting an H/ERV is to circulate the warm exhaust air through a frosted passage in the heat exchanger core prior to drawing out the warm exhaust air. This method is typically accomplished with one or more dampers that block a supply of incoming fresh air and cause the warm exhaust air to pass through both passages of the H/ERV. Such a method is described in co-owned U.S. Pat. No. 5,632,334.

The damper may be powered by a drive (e.g., a motor) that moves the damper between a first position in which the damper allows an incoming fresh airflow into the H/ERV during a ventilation mode and a second position in which an inlet through which an incoming cold fresh airflow is blocked during a defrost mode. However, when the H/ERV is in the ventilation mode and the fresh air is at a temperature below freezing, the damper can freeze in the first position. Consequently, the damper can no longer move to the second position for the defrost mode.

Attempting to maintain full power of the motor driving the damper when the damper is frozen in the first position results in the cold ambient temperature creating grease viscosity drag on the motor. At the cold ambient temperature, the grease may be more viscous and may create resistance on moving parts of the motor, reducing its power. To determine a position of the damper, and whether it is moving or stopped, current variations from the motor may be detected. However, current draw variation may increase due to motor tolerances causing problems in determining the damper position. To address these issues, a high torque motor may be utilized to provide the necessary force to dislodge the damper frozen in the first position. However, with such a motor, the amount of torque may be sufficient to cause failure from stress on the motor and surrounding parts during normal operation. A control circuit may be used to control the amount of torque and temperature dependence of the torque such that temperature could be compensated and torque could be limited during normal operation to prevent component damage. However, even when these modifications are made, the damper may still be prone to freezing in very cold temperatures.

### SUMMARY

The present disclosure provides a heat or energy recovery ventilator unit which addresses at least one of the above-mentioned disadvantages of the art or provides a useful alternative.

### BRIEF DESCRIPTION OF THE DRAWINGS

Embodiments will now be described, by way of example only, with reference to the attached figures, in which:

FIG. 1 shows a perspective view of a heat or energy recovery ventilator (H/ERV) with a blower assembly in which a heat exchanger core and a damper assembly removed;

FIG. 2 shows an exploded view of the H/ERV depicting the blower assembly, the heat exchanger core and the damper assembly;

FIG. 3 shows an exploded view of the H/ERV with the blower assembly, heat exchanger core and damper and first and second airflow streams;

FIG. 4 is a block diagram of a damper controller system according to an embodiment; and

FIG. 5 is a block flow diagram illustrating a method of operating a damper in the H/ERV according to an embodiment.

### DESCRIPTION OF SELECTED EMBODIMENTS

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to specific embodiments described below but rather, include all alternatives, modifications, and equivalents.

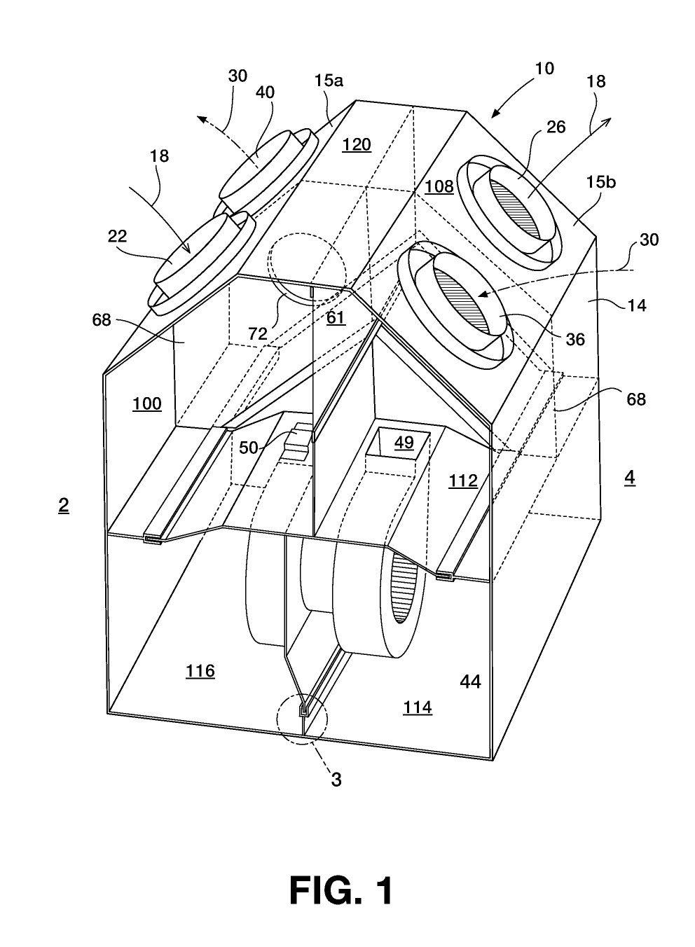

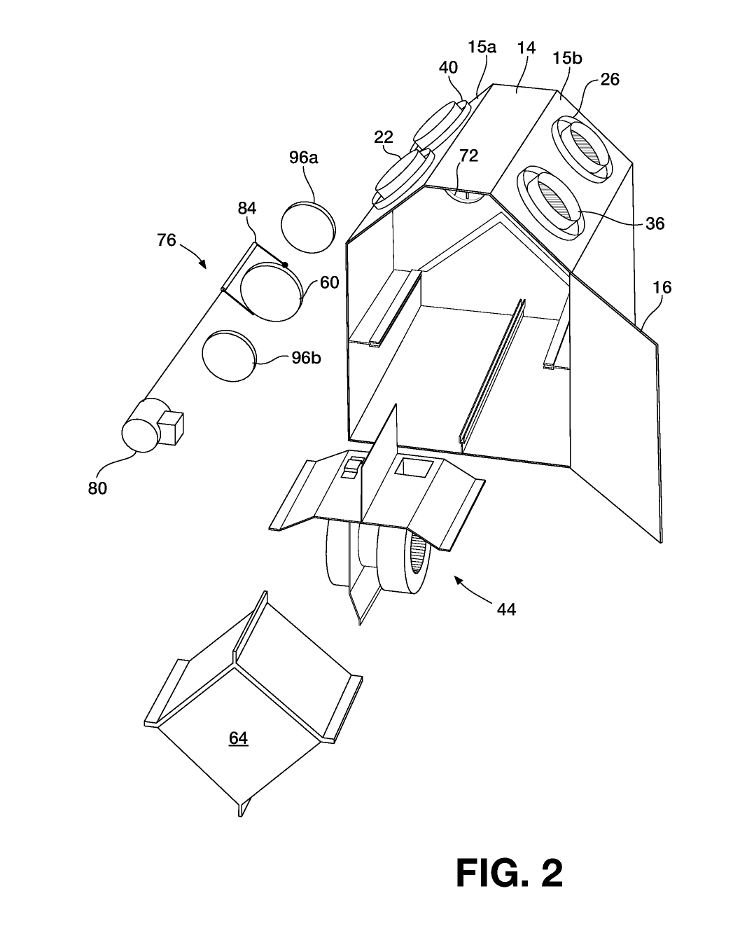

FIGS. 1 and 2 show a heat or energy recovery ventilator (H/ERV) 10 in accordance with an embodiment. The H/ERV 10 includes a housing 14 having a pair of faces 15a, 15b forming a top of the housing 14. Face 15a is disposed towards an exterior 2 of a building and face 15b is disposed towards an interior 4 of the building when the H/ERV 10 is installed. A door 16, as best seen in FIG. 2, closes the housing 14 and seals the H/ERV 10 to inhibit air infiltration/exfiltration when the H/ERV 10 is in use.

To show the internal parts of the H/ERV 10 more clearly, a heat exchanger core 64 shown in FIG. 2 is omitted in FIG. 1. The heat exchanger core 64, illustrated in FIG. 2, is oriented such that two of its faces, inlet faces, are substantially parallel to faces 15a, 15b of the housing 14.

The housing 14 includes a first divider wall 68 and a second divider wall 61 (both of which are illustrated by dotted lines) that extend from a top of housing 14 at approximately right angles to each other. The first divider wall 68 includes a triangular aperture through which a blower assembly 44 passes as it is slid into a rear of the housing 14 and against which the heat exchanger core 64 abuts in a seated manner when the heat exchanger core 64 is inserted into the housing 14.

When the blower assembly 44 and the heat exchanger core 64 are in position in the H/ERV 10, the H/ERV 10 is divided into at least four compartments via the first and divider walls 68, 61. A third divider wall 3 may extend around the blower assembly 44 in a general direction of the second divider wall 61. A fourth divider wall 12 may form a floor that is substantially parallel to a bottom of the housing 14. The third divider wall 3 and the fourth divider wall 12 may form an additional two compartments around the blower assembly 44. Upper compartments formed by the first and second divider walls 68, 61 and lower compartments formed by the third and fourth divider walls 3, 12 may be arranged in a series of three compartments with each series of compartments forming one of a fresh airflow path 18 and an exhaust airflow path 30. The blower assembly 44 induces the airflow paths 18 and 30 through the H/ERV 10.

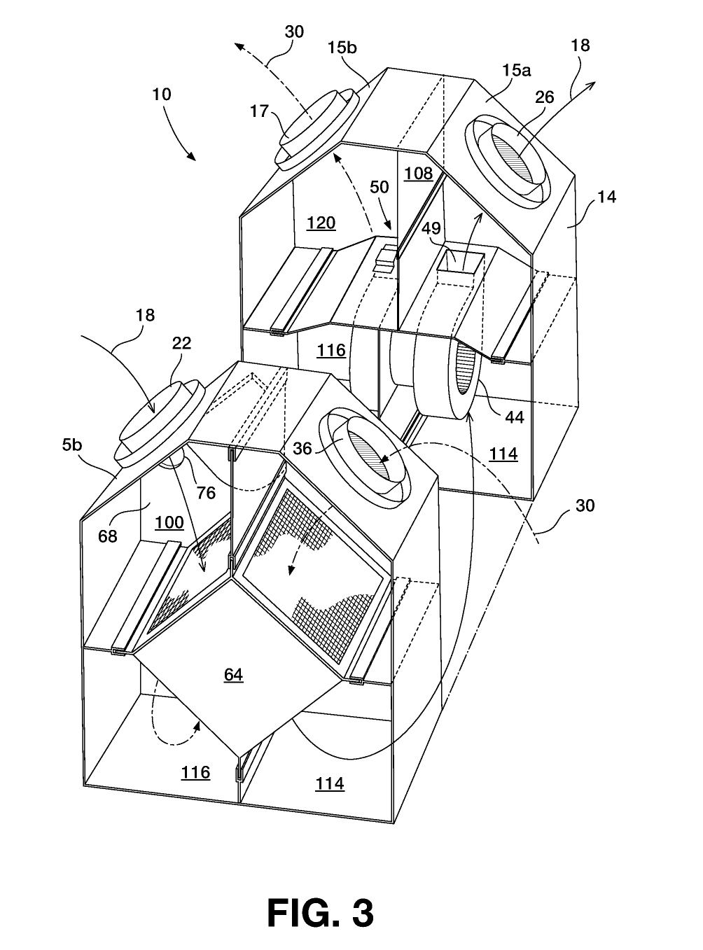

The incoming fresh airflow path 18 moves from a first inlet 22 formed in face 15b from the exterior 2 of the building to a first outlet 26 formed in face 15b positioned towards the interior 4 of the building to provide fresh air to the interior 4. The first outlet 26 is located in an opposite quadrant of the upper compartments of the H/ERV 10 from the first inlet 22. The air in the fresh airflow path 18 is drawn into the first inlet 22 to compartment 100 and then through a face of the heat exchanger core 64 that is in compartment 100 (as illustrated in FIG. 3). In the heat exchanger core 64, the fresh, cooler air in the fresh airflow path 18 is heated via warm exhaust air drawn from the interior 4 of the building. The heated fresh air along the fresh airflow path 18 is drawn through the heat exchanger core 64 into compartment 114 and then into the blower assembly 44 in compartment 114. The fresh air along the fresh airflow path 18 exits the blower assembly 44 through outlet 49 into compartment 108. The fresh air along the fresh airflow path 18 exits the H/ERV 10 from compartment 108 through the first outlet 26 and into the interior 4 of the building

The outgoing exhaust airflow path 30, containing warm exhaust air from the interior 4 of the building, moves from a second inlet 36 formed in face 15b positioned towards the interior 4 of the building to a second outlet 40 formed in face 15a towards the exterior 2 of the building. In a manner similar to the relative locations of the first outlet 26 and the first inlet 22, the second outlet 40 is located in an opposite quadrant of the upper compartments of the H/ERV 10 from the second inlet 36. The air in the exhaust airflow path 30 is drawn into the second inlet 36 to compartment 112 and then through a face of the heat exchanger core 64 that is in compartment 112 (as illustrated in FIG. 3). In the heat exchanger core 64, the warmer exhaust air in the exhaust airflow path 30 is cooled by heat exchange with the fresh airflow path 18. The cooled exhaust air along the exhaust airflow path 30 is drawn through the heat exchanger core 64 into compartment 116 and then into the blower assembly 44 in compartment 116. The exhaust air along the exhaust airflow path 30 exits the blower assembly 44 through outlet 50 into compartment 120. The exhaust air along the exhaust airflow path 30 exits the H/ERV 10 from the compartment 120 through the second outlet 40 and to the exterior 2 of the building.

FIG. 3 illustrates the fresh airflow path 18 and the exhaust airflow path 30 through the H/ERV 10 in a ventilation mode. The fresh airflow path 18 originating from the exterior 2 of the building is shown as a solid line and the exhaust airflow path 30 originating from the interior 4 of the building is shown as a dotted line.

As shown in FIG. 1, a port 72 is provided in the divider wall 68 between compartment 100 and compartment 120. The port 72 may be opened or closed by a damper 76 (shown in FIG. 2) located in compartment 100. The damper 76 may also close the first inlet 22.

In a ventilation mode in the H/ERV 10, the port 72 is closed by the damper 76 and the first inlet 22 is open. In the ventilation mode, cool air entering in the fresh airflow path 18 is allowed to flow through the first inlet 22 and then through an adjacent face of the heat exchanger core 64 (shown in FIG. 2). In the ventilation mode with the first inlet 22 open and the port 72 closed, the damper 76 is in a ventilation mode position.

If the first inlet 22 is closed by the damper 76, cold air may be prevented from entering into the H/ERV 10 via the fresh airflow stream 18. When the first inlet 22 is closed by the damper 76, the port 72 is open in a defrost mode in which warm air along the exhaust airflow path 30 from the interior 4 of the building may circulate through the H/ERV 10 for defrosting thereof. In the defrost mode with the first inlet 22 closed and the port 72 open, the damper 76 is in a defrost mode position.

The components of the damper 76 are shown in more detail in FIG. 2. A body 60 of the damper 76 corresponds to a shape of the first inlet 22 and the port 72, which in this embodiment are both circular, although alternative shapes are possible. Foam sealing member 96a and 96b may be attached to each side of the body 60 for insulation and sealing. A gate 84 may be attached to the body 60 and rotatably attached to an interior wall of the H/ERV 10 such that rotation of the gate 84 moves the body 60 from the ventilation mode position against the port 72 to the defrost mode position against the first inlet 22. The gate 84 may be attached to the interior wall of the H/ERV 10 by a bracket (not shown) that allows for suitable rotation thereof.

A motor 80 is operably connected to the gate 84 to move the damper 76 between the ventilation mode position and the defrost mode position. The motor 80 may have a drive shaft (not shown) connected to the gate 84 for movement thereof. For example, the gate 84 may be connected to the motor 80 such that the gate 84 and the body 60 rotate about a shaft (not shown) of the motor 80 during actuation thereby.

The motor 80 may be, for example, a reversible electric motor with a gear reduction assembly to provide high torque at low power. The motor 80 may use an H bridge drive configuration to enable clockwise and counter clockwise rotation. The H bridge is an electronic circuit that enables a voltage to be applied across the motor 80 in either direction and allows the motor 80 to change its rotation from clockwise to counter-clockwise.

In the ventilation mode, the damper 76 may be prone to being frozen in the ventilation mode position on the port 72 when a temperature of the exterior 2 of the building is below a freezing temperature. As air from the exhaust airflow path 30 enters the compartment 112 when the H/ERV 10 is in the ventilation mode, this air will pass through the heat exchanger core 64. Moisture in the air from the exhaust airflow path 30 condenses within the compartment 100 in which the damper 76 is located. This may cause the damper 76 to freeze in the ventilation mode position on the port 72 and prevent the H/ERV 10 from switching to the defrost mode in which the damper 76 blocks the first inlet 22.

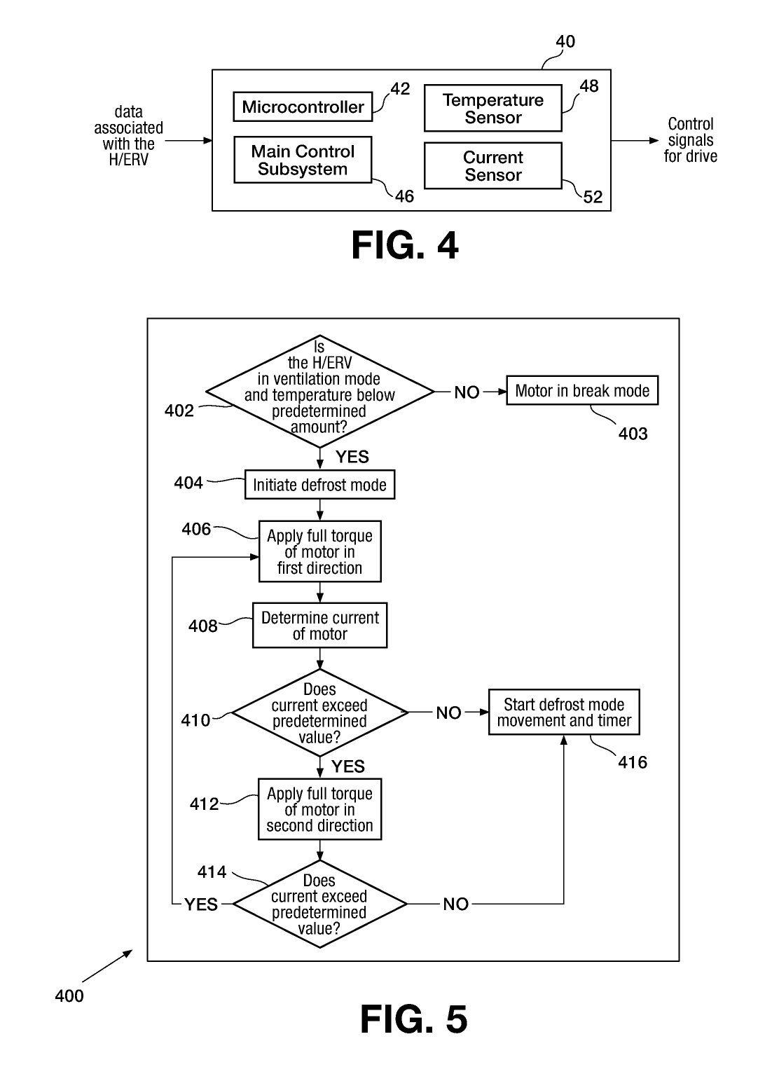

As shown in FIG. 4, the motor 80 may be connected to a damper control system 40, which comprises a microcontroller 42, a main control subsystem 46, a temperature sensor 48 and a current sensory 52.

The temperature sensor 48 may be a temperature sensor located in compartment 100 in the vicinity of the first inlet 22 for detecting a temperature therein. The temperature sensor 48 may be a separate component or may be implemented in coordination with the microcontroller 42 or the main control subsystem 46.

The current sensor 52 may receive current draw from the motor 80 to provide an indication of the torque on the motor 80. The current draw sensor 52 may include a resistor measuring a voltage drop thereacross to use as an indication of torque on the motor 80. The current sensor 52 may be a separate component or may be implemented in the microcontroller 42 or the main control subsystem 46. Full current may be detected when the voltage drop across the resistor is above to a predetermined value such that the higher the current draw of the motor 80, the higher the torque and the greater the voltage drop.

The microcontroller 42 may generate control signals to operate the motor 80 and may receive data associated with the motor 80. The microcontroller 42 may receive signals from the main control subsystem 46 including control signals indicating that the motor 80 is to operate such that the drive shaft rotates clockwise, counterclockwise or has no movement. The microcontroller 42 may receive or obtain a temperature of the damper 76 from the temperature sensor 48 and an indication of torque on the motor 80 from the current sensor 52. With these inputs, the microcontroller 42 may find clockwise and counterclockwise stop positions for the drive shaft such that the body 60 of the damper 76 is moved to block either the first inlet 22 in the defrost mode position or the port 72 in the ventilation mode position. These stop positions are determined by the microcontroller 42 when the microcontroller 42 detects a maximum torque from the motor 80 and records a time for the body 60 to travel between stops. These stop positions may be determine once upon system initialization, at periodic intervals during the life of the H/ERV or in response to some other action.

The main control subsystem 46 provides control signals to the microcomputer 42 and receives data therefrom.

When the microcontroller 42 receives an input to rotate the damper 76 from one position to the other, the microcontroller 42 sends a signal to the motor 80 to apply maximum torque to rotate for a period of time less than the time required to reach the desired stop position. The microcontroller 42 then sends a signal to the motor 80 to reduce the torque until the stop position is reached. By reducing the torque, damage to the damper 76 can be prevented. When the drive shaft of the motor 80 reaches the stop position, the microcontroller 42 sends a signal to the motor 80 to further reduce the torque to minimize power consumption while maintaining a seal with the body 60 of the damper 76 against either the first inlet 22 or the port 72 depending on the stop position.

Control signals from the microcontroller 42 to the motor 80 may be pulse width modulated to enable modulation of motor torque by enabling short pulses of voltage to be delivered to the motor 80 so the motor 80 will have less torque and move more slowly that it would without PWM. PWM allows for adjustment of the torque of the motor 80 at the same time as the speed of the motor 80. As the pulse duration and frequency of the pulse width modulated control signals to the motor 80 increase, the motor 80 is energized more often and the torque and speed of the motor 80 increases. It has been found that using PWM may be more effective than employing full motor power without PWM. Allowing 100% power without PWM to break ice formations may create issues when the damper 76 is frozen in the ventilation mode position. Power may need to be cut prior to the motor 80 reaching its final stop. Inertia may carry the motor 80 too far and subsequent torque stress can damage the gear box and/or strip a damper arm connection. Travel time for the damper 76 may be determined, the period for 100% power for the motor 80 may be limited and conditional balance time using a lower % PWM drive signal may be used to achieve the final position. However, this may still result in the damper 76 occasionally freezing shut in very cold conditions.

The clockwise and counter-clockwise motion of the motor 80 may induce flex where the body 60 of the damper 76 touches the first inlet 22 or the port 72, improving effectiveness in breaking any ice more than that of a steady full torque force.

FIG. 5 is a flow diagram of an embodiment of a method 400 of operating the damper 76. The damper control system 40 of FIG. 4 may perform the method 400.

A determination may be made by a processor at step 402 to determine whether the H/ERV 10 is in the ventilation mode and whether the temperature is less than a predetermined temperature (e.g., −10° C.). The processor may be the main control subsystem, the microcontroller or a separate processor depending on the implementation. If the H/ERV 10 is in the ventilation mode and the temperature is less than the predetermined temperature, then a defrost mode cycling may be initiated at step 404. If the H/ERV 10 is not in the ventilation mode and the temperature is not less than the predetermined temperature, then the defrost mode cycling is not initiated and the motor 80 is put in brake mode 403 (stop). In defrost mode cycling, the H/ERV may cycle between the ventilation mode and the defrost mode on a set cycle. For example, the H/ERV 10 may be in ventilation mode for 30 minutes and in defrost mode for 3 minutes although other cycles and other mechanisms of entering the defrost mode are contemplated and possible.

In step 406 full torque of the motor 80 is applied in a first direction. Depending on a configuration of the motor 80 and the drive shaft of the motor 80 with respect to the damper 76, the port 72 and the first inlet 22, the first direction for the full torque of the motor 80 may be in a clockwise or in a counterclockwise direction depending on which of these directions will rotate the damper 76 from the port 72 towards the first inlet 22. The main control subsystem 46 may set this direction according to an actual implemented relative position of these components. Due to the torque of the motor 80, the defrost mode in certain embodiments may be initiated at temperatures below the predetermined temperature. Moreover, according to selected embodiments, the defrost mode may be initiated when the H/ERV 10 is in the ventilation mode, since, during this mode of operation, condensation freezes in a vicinity of the damper 76 and may freeze the damper 76 in place on the port 72.

The current of the motor 80 when the full torque is applied in measured in step 408. The current may be measured by a resistor on the main control subsystem 46 of the damper control system 40 (see FIG. 4). In step 410 it is determined whether the current exceeds a predetermined value. Depending on the implementation of the current sensor 52, full current may be detected when the voltage drop measured across a resistor is above a predetermined value. Such a predetermined value can be readily determined by those of ordinary skill in the art.

If the current is below a predetermined value, this may indicate that the damper 76 is free to move (i.e., not in a frozen state on the port 72) and movement of the damper 76 into the defrost mode position is started in step 416.

Full current at the motor 80 may indicate that the damper 76 is frozen in the ventilation mode position on the port 72 of the H/ERV 10. The motor 80 is actuated in step 412 to dislodge the damper 76 frozen in the ventilation mode position on the port 72. The motor actuation in step 412 is in a second direction, which is opposite to the first direction. If the first direction is in a clockwise direction then the second direction is in a counterclockwise direction and if the first direction is in a counterclockwise direction then the first direction is in a clockwise direction. and the motor 80 is stopped in step 403 in a brake mode. The motor 80 is actuated in step 412 via a pulse width modulated signal applying a short burst of power to the motor 80.

After the motor 80 is actuated in step 412 to dislodge it from the ventilation mode position, the current is measured again in step 414. If full current is detected in step 414, then full torque of the motor 80 is applied once again in the first direction in step 406. The current of the motor 80 is determined in step 408 as described previously and if the current exceeds a predetermined value in step 410, then this indicates that the damper 76 is still frozen in the ventilation mode position, and the motor 80 is activated in the second direction in step 412. If full current is still detected in step 414, the steps 406, 408, 410 and 412 are repeated until full current is no longer detected. When full current is no longer detected in step 414, the motor 80 is activated to move the damper 76 into the defrost mode position in step 416. In other words, the cycles of the motor 80 being actuated in the first direction and the second direction are repeated until the damper 76 is released from the ventilation mode position.

It is contemplated that the materials described above may be substituted without departing from the scope of the invention. For example, although the above-described drive is an electrical motor, it is contemplated that vacuum motors, solenoids or air cylinders could also be utilized. Also, the blower may be any suitable device including individual blower/motor units. It is further contemplated that the housing, gate and divider wall may be fabricated from any suitable material including sheet metal, plastic and/or fibreglass

Although the above description uses metric units for measurement, it will be understood that any appropriate measurement unit and any appropriate measurement system may also be used. The use of a particular measurement unit in the above description does not limit the present techniques to only the use of the above units that were used for ease of explanation of the present techniques.

While the present techniques may be susceptible to various modifications and alternative forms, the embodiments discussed above have been shown only by way of example. However, it should again be understood that the techniques are not intended to be limited to particular embodiments disclosed herein. Indeed, the present techniques include all alternatives, modifications and equivalents falling within the scope hereof.

1. A heat or energy recovery ventilator having a ventilation mode and a defrost mode comprising:
a housing having inlets and outlets and containing therein internal chambers each having located therein one of the inlets and the outlets;
a heat exchanger core positioned in the housing so as to operatively connect at least one of the inlets with at least one of the outlets;
a blower for inducing air flow from the at least one of the inlets to the at least one of the through the heat exchanger core;
a damper located in one of the internal chambers and being movable between a ventilation mode position and a defrost mode position;
a damper control system comprising:
a drive for moving the damper between the ventilation mode position and the defrost mode position, where the heat or energy recovery ventilator is in the ventilation mode when the damper is in the ventilation mode position and in the defrost mode when the damper is in the defrost mode position; and
a processor for controlling the drive, the processor being configured to detect when the damper is stuck in the ventilation mode position and to alternate direction of the drive between clockwise rotation and counter clockwise rotation to release the damper from the ventilation mode position.

2. The heat or energy recovery ventilator of claim 1, wherein the damper control system further comprising a temperature sensor to detect a temperature of fresh air from one of the inlets, wherein the processor is configured to detect when the temperature detected by the temperature sensor is less than a predetermined value and cause the heat or energy recovery ventilator to enter the defrost mode when the temperature is less than the predetermined value by effecting movement of the drive to move the damper from the ventilation mode position to the defrost mode position.

3. The heat or energy recovery ventilator of claim 1, wherein the damper control system further comprising a current detector to detect current from the drive and wherein the processor is further configured to receive the detected current from the current detector to determine when the current exceeds a predetermined value indicating that the damper is stuck.

4. The heat or energy recovery ventilator of claim 1, wherein the drive comprises an electric motor that is operable for both clockwise rotation and counter clockwise rotation.

5. The heat or energy recovery ventilator of claim 4, wherein one of clockwise rotation and counter clockwise rotation is set as a defrost direction to move the damper from the ventilation mode position to the defrost mode position and the other of clockwise rotation and counter clockwise rotation is set as a ventilation direction to move the damper from the ventilation mode position to the defrost mode position.

6. The heat or energy recovery ventilator of claim 5, wherein the processor is configured to effect the motor to apply full torque in the defrost direction to move the damper from the ventilation mode position to the defrost mode position.

7. The heat or energy recovery ventilator of claim 6, wherein the processor is further configured to detect that the damper is stuck in the ventilation mode position when the motor is moving in the defrost direction and the detected current exceeds the predetermined value, and to sequentially alternate the motor between clockwise rotation and counter clockwise rotation to release the damper from the ventilation mode position when the damper is detected to be stuck in the ventilation mode position.

8. The heat or energy recovery ventilator of claim 7, wherein the processor is further configured to stops the sequentially alternating rotation of the motor when the current of the motor falls below the predetermined value.

9. The heat or energy recovery ventilator of claim 1, wherein the housing includes a fresh inlet, a fresh outlet, an exhaust inlet and an exhaust outlet, and four chambers each of which contains one of the fresh inlet, the fresh outlet, the exhaust inlet and the exhaust outlet, and wherein the heat exchanger core operatively connects the fresh inlet with the fresh outlet and the exhaust inlet with the exhaust outlet.

10. The heat of energy recovery ventilator of claim 9, further comprising a port positioned in a wall between one of the four chambers having the fresh inlet and another of the four chambers having the exhaust outlet.

11. The heat of energy recovery ventilator of claim 10, wherein the damper is positioned over the port when the damper is in the ventilation mode position and is positioned over the fresh inlet when the damper is in the defrost mode position.

12. The heat of energy recovery ventilator of claim 4, wherein the motor is modulated by a pulse width modulation signal.

13. A system for defrosting a heat or energy recovery ventilator having a housing having inlets and outlets and containing therein internal chambers each having located therein one of the inlets and the outlets, a heat exchanger core positioned in the housing so as to operatively connect the at least one of the inlets with at least one of the outlets and a blower for inducing air flow from the at least one of the inlets to the at least one of the through the heat exchanger core, the system comprising:
a damper located in one of the internal chambers and being movable between a ventilation mode position and a defrost mode position;
a damper control system comprising:
a drive for moving the damper between the ventilation mode position and the defrost mode position, where the heat or energy recovery ventilator is in the ventilation mode when the damper is in the ventilation mode position and in the defrost mode when the damper is in the defrost mode position; and
a processor for controlling the drive, the processor being configured to detect when the damper is stuck in the ventilation mode position and to alternate direction of the drive between clockwise rotation and counter clockwise rotation to release the damper from the ventilation mode position.

14. The system of claim 13, wherein the damper control system further comprising a temperature sensor to detect a temperature of fresh air from one of the inlets, wherein the processor is configured to detect when the temperature detected by the temperature sensor is less than a predetermined value and cause the heat or energy recovery ventilator to enter the defrost mode when the temperature is less than the predetermined value by effecting movement of the drive to move the damper from the ventilation mode position to the defrost mode position.

15. The system of claim 13, wherein the damper control system further comprising a current detector to detect current from the drive and wherein the processor is further configured to receive the detected current from the current detector to determine when the current exceeds a predetermined value indicating that the damper is stuck.

16. The heat or energy recovery ventilator of claim 13, wherein the drive comprises an electric motor that is operable for both clockwise rotation and counter clockwise rotation, wherein one of clockwise rotation and counter clockwise rotation is set as a defrost direction to move the damper from the ventilation mode position to the defrost mode position and the other of clockwise rotation and counter clockwise rotation is set as a ventilation direction to move the damper from the ventilation mode position to the defrost mode position, wherein the processor is configured to effect the motor to apply full torque in the defrost direction to move the damper from the ventilation mode position to the defrost mode position.

17. The system of claim 16, wherein the processor is further configured to detect that the damper is stuck in the ventilation mode position when the motor is moving in the defrost direction and the detected current exceeds the predetermined value, and to sequentially alternate the motor between clockwise rotation and counter clockwise rotation to release the damper from the ventilation mode position when the damper is detected to be stuck in the ventilation mode position.

18. The system of claim 17, wherein the processor is further configured to stops the sequentially alternating rotation of the motor when the current of the motor falls below the predetermined value.

19. The system of claim 13, wherein the housing includes a fresh inlet, a fresh outlet, an exhaust inlet and an exhaust outlet, and four chambers each of which contains one of the fresh inlet, the fresh outlet, the exhaust inlet and the exhaust outlet, and wherein the heat exchanger core operatively connects the fresh inlet with the fresh outlet and the exhaust inlet with the exhaust outlet, wherein the housing has a port positioned in a wall between one of the four chambers having the fresh inlet and another of the four chambers having the exhaust outlet, wherein the damper is positioned over the port when the damper is in the ventilation mode position and is positioned over the fresh inlet when the damper is in the defrost mode position.

20. A method of defrosting a heat or energy recovery ventilator, comprising:
detect conditions for the heat or energy recovery ventilator to enter a defrost mode from a ventilation mode;
generate a signal for a motor to apply full torque in a first direction to move a damper from a ventilation mode position to a defrost mode position;
detect current from the motor to determine if the motor is at maximum torque; and
generate signals for the motor to apply full torque in an alternating pattern between a second direction and a first direction until the current from the motor indicates that the motor

21. A computer program product comprising a computer readable memory storing computer executable instructions thereon that when executed by a microcontroller implement the method of claim 20.
